(19) United States
(12) Patent Application Publication
(10) Pub. No.: US 2013/0332018 A1
(43) Pub. Date: Dec. 12, 2013

(54) ROAD GUIDANCE SYSTEM FOR VISUALLY IMPAIRED

(71) Applicant: Ji Hun Kim, Daegu (KR)

(72) Inventor: Ji Hun Kim, Daegu (KR)

(21) Appl. No.: 13/981,680

(22) PCT Filed: Jan. 16, 2012
(86) PCT No.: PCT/KR2012/000356

§ 371 Date: Jul. 25, 2013

(30) Foreign Application Priority Data
Jan. 26, 2011 (KR) 10-2011-0007939

(51) Int. Cl. A61H 3/06

(52) U.S. Cl. CPC A61H 3/061; Y10S 901/01; Y10S 901/47
USPC 701/22; 701/25; 901/1; 901/47

(57) ABSTRACT

A road guidance system for the blind. A plurality of RFID tags 10 are buried inside a pedestrian pavement 100 with information of said pavement 100 contained therein, along the pavement. A guide robot 20 has an RFID reader 21 for checking signals of said RFID tags 10 from said pavement 100 by passing therethrough, and an obstruction sensor 22 for sensing an obstruction. Wheels 23 are positioned on both sides of the guide robot. A controller 30 checks signals from said RFID reader 21 and said obstruction sensor 22 inside said guide robot 20, converts the checked information into voice signals and outputs the voice signals, and then controls the driving of said guide robot 20. A stick 40 is electrically connected to enable communication with said guide robot 20, thereby enabling safe loading and unloading.

### CROSS-REFERENCE TO RELATED APPLICATION

This application claims the benefit of Korean Patent Application No.10-2011-0007939, filed on Jan. 26, 2011 in the Korean Intellectual Property Office, the disclosure of which is incorporated herein by reference.

### TECHNICAL FIELD

The present invention relates to a road guidance system for visually impaired, and more specifically, to a road guidance system for the blind capable of guiding a walking of an impaired person such that the blind may walk safely by burying RFID tags along the pedestrian roads in order to memorize the information of circumstances nearby the road, sense obstructions in front of the blind and allow the blind to recognize such information beforehand through sound signals.

### BACKGROUND ART

In general, devices for safe walking of blind persons have been developed and proposed in various types, including a stick for guiding safer walking of the blind persons.

Currently, most of blind persons depend on sticks for visually impaired, and in some case guide dogs may be accompanied with the blind persons depending on their financial situation.

Additionally, Braille blocks for the blind are installed on the pavement to secure safe walking of the blind.

Such supplementary equipments merely improve safety of the walking of the blind; however, 100% safety thereof cannot be secured, and safety accidents are occurring frequently still despite those supplementary equipments.

Accordingly, a method of guiding safer walking for the blind has been proposed, in which RFID tags for informing road circumstances are buried in Braille blocks and a reader for reading the information from the RFID tags is embedded in a stick carried by the blind, thereby providing the road information to the blind through the RFID tags, but there are disadvantages that response time of the RFID tags is too long and that availability of Braille blocks is insufficient.

Accordingly, a guidance device with wheels has been proposed in the preceding patent of the same applicant, to which a stick is connected so that a blind can sense RFID tags and yellow color of crosswalks indication on the pedestrian road through this guidance device and more accurate road information can be provided to the blind.

However, even if road information is provided beforehand, the guidance device has to be pushed by a blind person's will and moreover the direction thereof has to be converted, thus when the blind deviates from a region where Braille blocks or RFID tags is embedded, the blind may be bewildered and confused in direction, causing risky walking and particularly the blind may fail to escape a collision at stairs or an obstruction.

### DISCLOSURE

### Technical Problem

The present invention has been made in an effort to solve the above-described problems associated with prior art and it is an object of the present invention to provide a road guidance system for the blind, in which a driving speed, a braking and direction change of a guide robot is controlled automatically and manually so that the road guidance system can be easily operated and handled.

Additionally, another object of the present invention is to provide a road guidance system for the blind, in which the blind recognizes accurately the situation of the road or obstructions ahead of the blind through the guide robot and performs automatically detouring, direction conversion or the braking with respect to the obstructions according to the circumstances thereby to walk safely.

Particularly, another object of the prevent invention is to provide a road guidance system for the blind, in which magnets are buried in the roads where RFID tags are is difficult to be arranged and the guide robot moves only along the magnetic force range of the magnets thereby to secure safe walking.

### Technical Solution

According to an aspect of the first exemplary embodiment of the present invention, a road guidance system for the blind may include: a plurality of RFID tags that are buried along pedestrian roads for storing information of the pedestrian roads, where Braille blocks was formed already or the Braille blocks is difficult to be formed; a guide robot provided with a RFID reader for checking signals of the RFID tags from the pedestrian road, an obstruction sensor for sensing an obstruction ahead of the blind at a certain distance from the RFID reader, and wheels at both external sides, with which the guide robot advances and retreats by the driving of a motor; a controller inside the guide robot for checking signals from the RFID reader and the obstruction sensor, converting the checked information into sound signals and outputting them, and controlling the operation of the guide robot; and a stick whose bottom part is assembled detachably to the guide robot and electrically connected thereto such that communication with the guide robot is available.

In the configuration as described above, the RFID tags may be arranged on bus stops and subway platforms and further the RFID tags may be arranged to the door of bus and subway trains.

Additionally, the obstruction sensor may include an infrared sensor or a photo sensor.

Further, the motor maybe supplied with power by a charging cell, and the information received from the RFID reader and the obstruction sensor may be transmitted to the stick as sound information by wireless through an earphone or a Bluetooth reception earphone.

Particularly, a track may be formed by burying magnetic substance, wiring, or iron powder along the surface of the pedestrian roads and a sensor for sensing the magnetic substance, wiring, or iron powder may be provided to the guide robot so that the guide robot moves along a track in which the magnetic substance, wiring, or iron powder is buried.

### Advantageous Effects

According to the road guidance system for the blind of the present invention as configured above, it can be interconnected to the guiding system of the public transportation and subway while the RFID tags are buried at predetermined intervals along the pedestrian roads, thereby allowing the blind to ride on buses or subway trains safely. Specially, the moving speed of the guide robot can be controlled conveniently according to a blind person's will.

Additionally, according to the road guidance system for the blind of the present invention, a blind can recognize in advance an obstruction ahead of the blind or stairs to guide safer walking for the blind and prevent in advance a collision accident.

### DESCRIPTION OF THE DRAWINGS

FIG. 1 is a perspective view of a road guidance system for the blind, according to an embodiment of the present invention;

FIG. 2 is a side view of a guide robot, according to an embodiment of the present invention;

FIG. 3 is a plan view of a guide robot, according to an embodiment of the present invention, showing a shape of a RFID reader;

FIG. 4 is a side sectional view of a connective structure of a guide robot and a stick, according to an embodiment of the present invention;

FIG. 5 is a side view of a stick, according to another embodiment of the present invention; and

FIG. 6 is a block diagram showing a road guidance system for the blind, according to an embodiment of the present invention.

### DESCRIPTION OF THE REFERENCE NUMERALS IN THE DRAWINGS

10: RFID tag

20: guide robot

21: RFID reader

22: obstruction sensor

23: wheel

24: motor

240: adjustment switch

30: controller

40: stick

100: pedestrian road

### MODE FOR INVENTION

Hereinafter, exemplary embodiments of the present invention will be described below in more detail with reference to the accompanying drawings.

According to a road guidance system for the blind, a blind recognizes the signals from RFID tags when the blind passes by a pedestrian road while the RFID tags are buried in the pedestrian road, and walks safely on the pedestrian road according to sound signal.

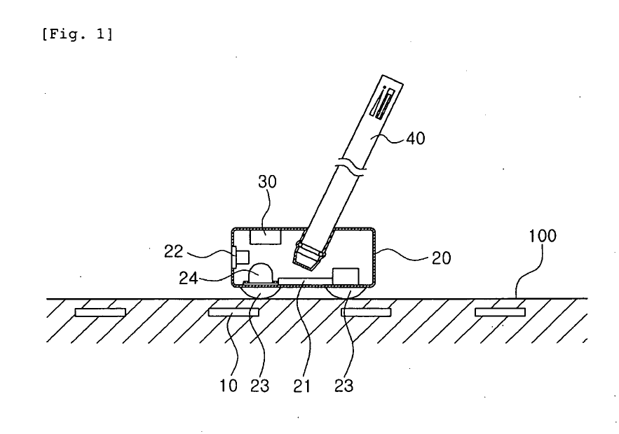

FIG. 1 is a perspective view of a road guidance system for the blind, according to an embodiment of the present invention.

As shown in FIG. 1, the road guidance system of the present invention allows the blind to be guided safely when the blind is walking on the pedestrian road, with receiving the information of pedestrian road 100 as sound signals, while RFID tags 10 are buried along the pedestrian road 100.

For the blind, Braille blocks have been already arranged on sidewalks along the pedestrian road 100 as a basic measure for guiding the blind and yellow lines have been drawn as an indication of footpaths on the pedestrian road 100 like roadways such as crosswalks on which the arrangement of Braille blocks is difficult to be formed.

The RFID tags 10 are commonly buried along the sidewalks paved with Braille blocks such that the information of the pedestrian road 100 is checked through a RFID reader that is arranged to a stick for the blind or to a guide device connected with the stick, and converted into sound again in order to guide the blind through sound signal.

Additionally, on crosswalks of roadways among pedestrian roads on which Braille blocks are difficult to be formed, yellow lines are drawn instead of such Braille blocks to enable walking of the blind and the yellow parts are checked with a guide device connected with a stick, thereby allowing sound signals be received together with safe walking guidance, which has been already suggested in the preceding application of the same applicant.

The road guidance system of the present invention includes mainly RFID tags 10, a guide robot 20, a controller 30 and a stick 40.

In an embodiment of the present invention, RFID tags 10 are buried at a predetermined distance along the pedestrian road 100 such as Braille blocks of sidewalks and crosswalks of roadways such that various road information including direction, etc., is stored therein, together with current location.

That is, the information that is necessary for a pedestrian such as the information of direction and or nearby road circumstances based on a current location is stored in RFID tags 10 and particularly information on risks on the side of sidewalks is also stored therein at the same time.

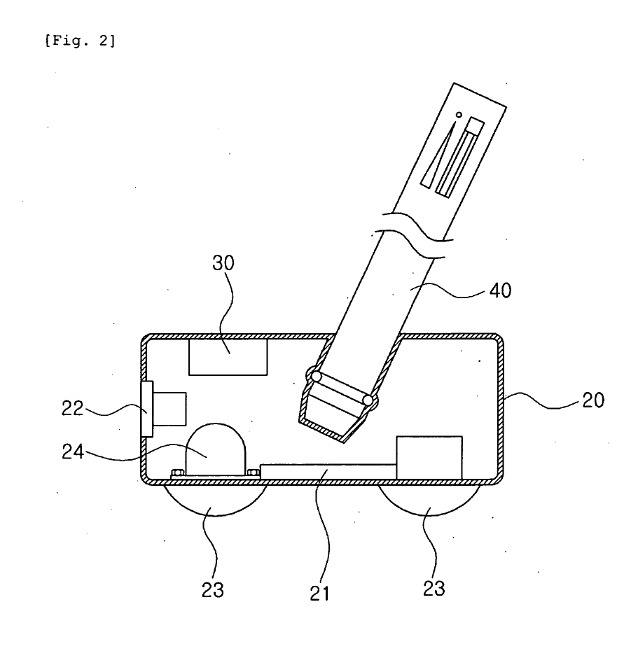

FIG. 2 is a side view of a guide robot according to an embodiment of the present invention wherein a guide robot 20 includes a RFID reader 21 for checking signals from RFID tags 10 that are buried in pedestrian road 100, an obstruction sensor 22 for sensing an obstruction ahead at a certain distance, and wheels 23 at both external sides that enable the guide robot to advance and retreat through the operation of a motor 24.

That is, the guide robot 20 advances and retreats with the wheels 23 that are rotated through the operation of the motor 24, which are provided on external parts thereof.

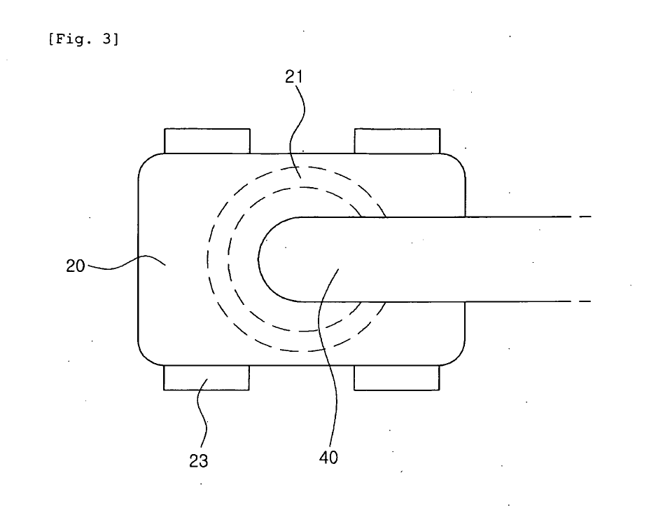

At this time, the RFID reader 21 may be arranged on the bottom or a floor surface of the guide robot 20 to receive the information from RFID tags 10 that are commonly buried in pedestrian road 100. Specially, the RFID reader 21 may be shaped to form a ring along the circumference of the floor surface of the guide robot 20 so as to ensure sufficient sensing area as shown in FIG. 3, that is, a shape of the RFID reader 21 may include various forms such as a circle to form a closed loop as illustrated in FIG. 3.

The wheels 23 that are mounted to the guide robot 20 may be arranged in two at both sides of the guide robot, respectively, or in four at a front and rear of the respective both sides thereof.

The guide robot may be provided with a power transmission mechanism for transferring power to the wheels 23 from the motor 24, and the motor 24 may be provided with a decelerator (not shown) for decelerating the rotation rate thereof. Specially, power may be applied to the motor 24 through a power charging cell (not shown).

Meanwhile, the obstruction sensor 22 that is mounted to the guide robot 20 may include an infrared sensor or a photo sensor for recognizing various obstructions such as stairs or walls at a certain distance from the guide robot 20.

Accordingly, the obstruction sensor 22 of an embodiment of the present invention maybe arranged in a front of the guide robot 20 and further the obstruction sensors may be preferably arranged at both sides thereof, respectively.

The controller 30 of the present invention is provided for guiding the road information with sound through an earphone by checking the information of the road and obstructions from the obstruction sensor 22 and the RFID reader 21, respectively, which are mounted to the guide robot 20, and then converting the information into sound signals.

Here, the information received from the RFID reader 21 and the obstruction sensor 22 is transmitted as sound information through an earphone or a Bluetooth reception earphone by wireless.

That is, the controller 30 receives information of the pedestrian road 100 from the RFID reader 21 and the obstruction sensor 22 that are mounted to the guide robot 20, converts the information valuable for informing to the blind among the received information into sound signal, and sends out guide signals through a portable receiver that is carried by the blind. In addition, the controller 30 stops or decelerates the operation of the motor 24 when the blind encounters a dangerous object or risky region during a walking to secure a safe walking.

That is, the controller 30 can automatically control the driving of the motor 24 through self operation.

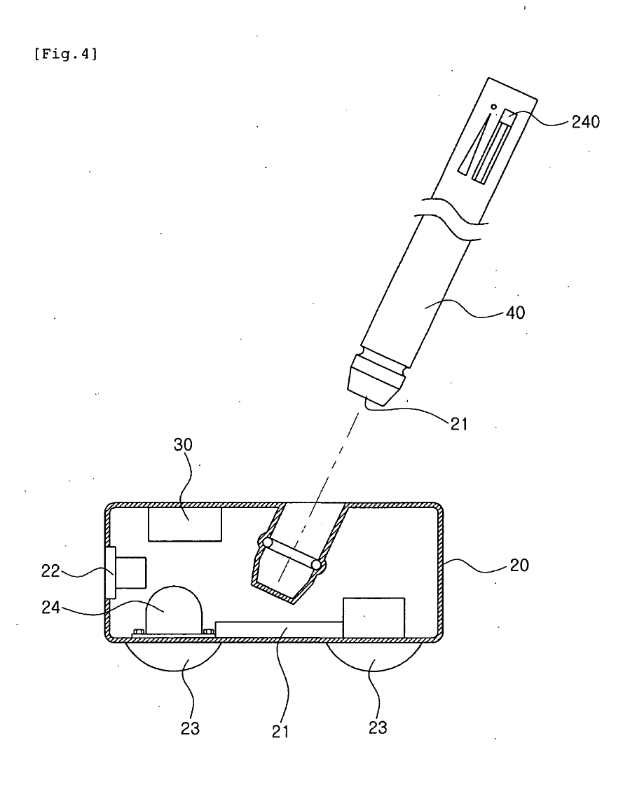

Meanwhile, a lower part of the stick 40 of the present invention is connected detachably to the guide robot 20, as shown in FIG. 4.

At this time, the stick 40 is connected electrically to the controller 30 of the guide robot 20 and further the driving of the motor 24 may be controlled manually with the stick 40.

Accordingly, the stick 40 may be provided with an adjustment switch 240 for controlling the driving of the motor 24 near the gripping part and auto-control by the controller 30 is blocked instantly when the motor 24 is controlled by an operation of the adjustment switch 240.

The adjustment switch 240 may be operated with fingers which are gripping the stick 40 and formed to be operated easily by the blind.

However, the stick 40 of the present invention may be configured to sense independently the RFID tags 10.

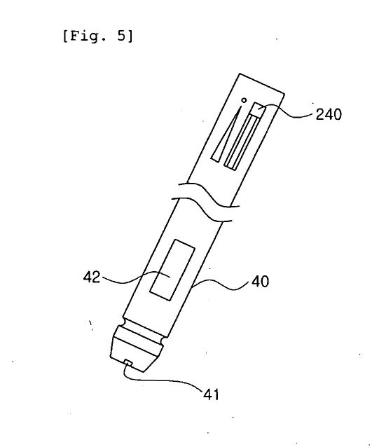

That is, as shown in FIG. 5, the RFID reader 41 may be mounted to the bottom part of the stick 40, which is connected to the guide robot 20, and the signal sensed by the reader 41 is transmitted to the controller 42 at the upper part of the reader and checked, thereby providing the road information to the blind as sound signals.

Meanwhile, the RFID reader 41 and the controller 42 provided to the stick 40 may actuated only when the stick 40 and the guide robot 20 are separated each other, and the RFID reader 41 and the controller 42 provided to the stick 40 may be controlled to operate or not to operate simultaneously through the RFID reader 21 and the controller 30 provided to the guide robot 20 when the stick 40 is connected to with the guide robot 20.

Additionally, a blind may be informed with a route of an incoming bus and a stop position of the bus as sound signals when the blind reaches to a bus riding zone in the road through RFID tags 10 that are installed within the bus riding zone.

Specially, the RFID tags 10 may be provided at an entrance of a bus for the blind to find correctly the entrance of the bus.

Like the bus riding zone, the RFID tags 10 may be buried in the pedestrian passages and loading/unloading zone of a subway platform to be interconnected to the guiding system of the conventional public transportation and the subway, thereby enabling safer loading and unloading of the blind on the public transportation.

Further, the RFID tags 10 may be buried in the border stones between roadways and sidewalks together with bollards on the road, and especially in dangerous zone to guide safe walking for the blind.

Meanwhile, the obstruction sensor 22 and the motor 24 may be provided to the guide robot 20 of the present invention, and the controller 30 for receiving the information from the obstruction sensor 22 and the motor 24 and controlling the driving of them may be provided to the stick 40.

Here, the RFID reader 21 may be provided to the bottom part of the stick 40 in order to receive stably road guidance through the stick 40 even when the stick 40 is separated from the guide robot 20.

When the RFID reader 21 is mounted to the stick 40, the stick 40 may be inserted very deeply into the guide robot 20 and the RFID reader may be connected electrically to the obstruction sensor 22 and the motor 24 of the guide robot 20 through the connecting of the stick 40.

Particularly, according to an embodiment of the present invention, a track along which the guide robot 20 moves may be formed along the surface of the pedestrian road 100 with burying magnetic substance, wiring, or iron powder therein and a sensor for sensing magnetic substance, wiring, or iron powder that are buried in the pedestrian roads 100 is provided to the guide robot 20 so that the guide robot 20 travels safely along the magnetic material buried in the pedestrian road 100.

Hereinafter, the operation of a road guidance system for the blind according to the present invention will be described in detail.

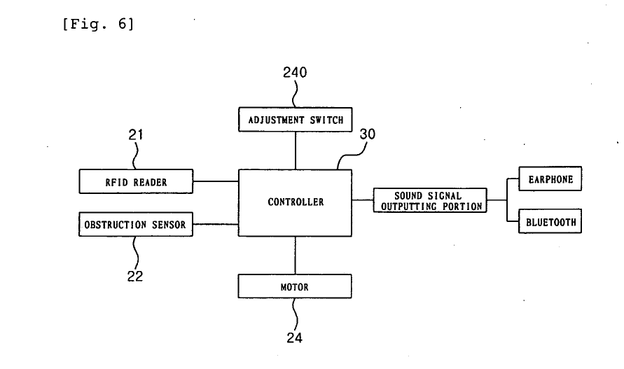

FIG. 6 is a block diagram showing a road guidance system for the blind, according to an embodiment of the present invention.

The road guide system may be arranged at various locations among paved roads, where the RFID tags 10 can be buried, and information on the pedestrian road 100, nearby circumstances and direction is stored in the RFID tags 10.

The RFID tags 10 are arranged at a bollard or at border stones between or roadways and sidewalks, or crosswalks, bus stops, subway platform as well as common pedestrian roads.

Further, the RFID reader 21 for reading signals from RFID tags 10 that are buried in pedestrian road 100 is provided to the guide robot 20 that is connected to the bottom part of the stick 40, and the obstruction sensor 22 for recognizing various obstructions such as walls, stairs and others formed and installed at certain height from the pedestrian road 100 is provided to the guide robot 20 as well so that the blind can recognize in advance the obstructions that may preclude walking on the road 100 or invite danger and respond rapidly to the obstructions.

That is, when the blind connects the stick 40 to the guide robot 20 and power is applied to the stick 40, the guide robot 20 becomes driving-on state and thereafter, the obstruction sensor 22 and the RFID reader 21 check the circumstances of pedestrian road 100.

The blind receives information from the RFID tags 10 that are buried in pedestrian roads 100 through the RFID reader 21, as sound, and walks safely while recognizing accurately the circumstances of pedestrian road 100.

When a blind is walking on the pedestrian road 100, if there is any obstructions such as bollard, wall, etc. that are protruded upwardly from the pedestrian road 100 ahead of the blind, the blind is informed in advance with the existence of such obstructions by the obstruction sensor 22 to detour the obstructions safely.

The obstruction sensor 22 informs in advance the blind with sound signals by sensing dangerous objects ahead of the blind even when the blind walks on a region such as non-paved roads where the RFID tags 10 are not arranged. Specially, when a dangerous object exists in the direction of walking or the blind encounters a dangerous situation, the controller 30 stops or reverse the motor 24 to protect the blind from risks safely.

Meanwhile, recently a bypass road for the blind is arranged beside the stairs and the RFID tags 10 are buried to a front of the stairs to allow the blind to move safely through the bypass road.

The blind is informed with the route of a bus that is entering into a bus stop and the position of the bus entered at the bus stop through a plurality of RFID tags 10 that are arranged in the bus stops, to move to a desired location and further the blind rides on safely the bus through the RFID tags 10 that are mounted to a bus door.

Like a bus stop, such RFID tags 10 are also mounted to a subway platform so that the blind can get on/off safely an electric train.

Specially, the RFID tags 10 that are arranged in bus stops and subway platforms maybe interconnected to the guide systems of the public transportation and the subway to provide accurate and stable information of the bus and the subway to the blind.

Here, according to the road guidance system for the blind of the present invention the road information can be provided to the blind as sound signals from RFID tags 10 that are buried in pedestrian road 100 independently through the stick 40 while the stick 40 is separated from the guide robot 20.

That is, the RFID reader 41 for checking signals from the RFID tags 10 that are buried also in the stick 40 as well as the guide robot 20 and the controller 42 for outputting sound signals selectively according to the road information sensed from the RFID reader 41 is provided adjacently to the RFID reader such that the stick 40 is operated independently or together with the RFID reader 21 and the controller 30 that are arranged in the guide robot 20 at the same time.

As described above, according to the road guidance system for the blind of the present invention, the RFID tags 10 are buried in various locations of the pedestrian road 100 and the information of each of pedestrian roads 100 and the circumferences around the pedestrian roads 100 is stored simultaneously in the RFID tags 10 thereby to protect the blind safely from any risks.

Additionally, the guide robot 20 can move more easily with the driving of the motor 24 and further the guide robot 20 moves only along the track where magnetic material is buried, by a sensor mounted to the guide robot 20 while the magnetic material is buried in the pedestrian road 100, for the blind to walk safely and conveniently.

1. A road guidance system for the visually impaired, comprising:
a plurality of RFID tags (10) that are buried along pedestrian roads (100)for storing information of the pedestrian roads (100), wherein Braille blocks was formed already or the Braille blocks is difficult to be formed;
a guide robot (20) provided with a RFID reader (21) for checking signals of the RFID tags (10) from the pedestrian road (100), an obstruction sensor (22) for sensing an obstruction ahead of the blind at a certain distance from the RFID reader (21), and wheels (23) at both external sides, with which the guide robot (20) advances and retreats with the driving of a motor (24);
a controller (30) inside the guide robot (20) for checking signals from the RFID reader (21) and the obstruction sensor (22), converting the checked information into sound signals and outputting them, and controlling the operation of the guide robot (20); and
a stick (40) whose bottom part is assembled detachably to the guide robot (20) and electrically connected thereto such that communication with the guide robot (20) is available.

2. The road guidance system for the visually impaired of claim 1, wherein the RFID reader (21) is shaped to form a closed loop so as to have a maximum signal sensing range on the bottom surface of the guide robot.

3. The road guidance system for the visually impaired of claim 1, wherein the obstruction sensor (22) includes one of an infrared sensor or photo sensor.

4. The road guidance system for the visually impaired of claim 1, wherein the motor 24 is supplied with power by a charging cell.

5. The road guidance system for the visually impaired of claim 1, wherein the information received from the RFID reader (21) and the obstruction sensor (22) is transmitted to the stick (40) as sound information by wireless through an earphone or a Bluetooth reception earphone.

6. The road guidance system for the visually impaired of claim 1, wherein a track is formed with burying magnetic substance, wiring, or iron powder along the surface of the pedestrian roads (100) and a sensor for sensing the magnetic substance, wiring, or iron powder is provided to the guide robot (20) so that the guide robot (20) moves along a track in which the magnetic substance, wiring, or iron powder is buried.

7. The road guidance system for the visually impaired of claim 1, wherein a RFID reader (41) is buried in the bottom part of the stick (40) and a controller (42) for checking signals that are sensed from the RFID reader (41) and outputting road information as sound signals is embedded in a place adjacent to the RFID reader.

8. The road guidance system for the visually impaired of claim 2, wherein a RFID reader (41) is buried in the bottom part of the stick (40) and a controller (42) for checking signals that are sensed from the RFID reader (41) and outputting road information as sound signals is embedded in a place adjacent to the RFID reader.
